(19) United States
(12) Patent Application Publication
(10) Pub. No.: US 2002/0117652 A1
(43) Pub. Date: Aug. 29, 2002

(54) Silver-dispersed copper powder, process for producing the powder and conductive paste utilizing the powder

(75) Inventors: Kazushi Sano, Okayama-shi (JP); Yoshihiro Okada, Okayama-shi (JP); Hiromasa Miyoshi, Okayama-shi (JP); Yoshiomi Takada, Tokyo (JP)

Correspondence Address: McDERMOTT, WILL & EMERY, 600 13th Street, N.W., Washington, DC, 20005-3096, US

(73) Assignee: DOWA MINING CO., LTD.

(21) Appl. No.: 09/741,089

(22) Filed: Dec. 21, 2000

(51) Int. Cl. H01B 1/00

(52) U.S. Cl. 252/500

(57) ABSTRACT

Silver-dispersed copper powder whose particles have substantially no discrete metallic silver on their surfaces is produced by subjecting a silver-adhered copper powder composed of copper particles having silver adhered to the surfaces thereof to heat treatment in a non-oxidizing atmosphere at a temperature of 150-600° C. A conductive paste using the powder as filler resists migration.

### BACKGROUND OF THE INVENTION

1. Field of the Invention

This invention relates to a silver-dispersed copper powder suitable for use as conductive filler in past and the like, a process for producing the powder, and conductive paste using the powder.

2. Background Art

Conductive paste and paint are produced by dispersing conductive filler, specifically a metallic powder, in a resin binder or vehicle. The metallic powder used as the conductive filler is ordinarily copper powder or silver powder. Copper powder is cheaper than silver powder but is inferior in oxidation resistance. At temperatures higher than 110° C., moreover, it tends to form an oxidized film that degrades the thermal stability of conductive coating layer. Silver powder is excellent in both oxidation resistance and durability but readily causes migration and is expensive.

This led to the development of various methods for adhering or coating silver on the surfaces of copper powder particles. Japanese Patent Publications JPA. No.Sho.53-134759 (1988) and JPA. No.Sho.60-243277 (1985), for instance, teach methods of utilizing a silver complex salt solution to exchange precipitate metallic silver on copper powder particle surfaces, while JPA. No. Hei. 1-119602 (1989) teaches a method of dispersing copper powder in EDTA (ethylenediamine-tetraacetic acid) as a chelating agent to reduction-deposit silver on the powder surface. Particularly for suppressing migration caused by silver, on the other hand, JPA. No.Sho. 61-67702 (1986) teaches coating the surfaces of copper particles with silver and a titanate coupling agent and JPB.No.Sho 6-72242 (1994) teaches rapid cooling and solidification of a Cu—Ag melt in a stream of inert gas to obtain a powder composed of particles having a region progressively increasing in silver concentration from the interior toward the surface.

When silver is deposited on the surfaces of copper particles using a silver complex salt solution or EDTA, the particle surfaces assume a property substantially identical to metallic silver. Migration is therefore markedly more likely to occur than in the case of copper powder. While a powder obtained by these methods exhibits improved conductivity and oxidation resistance over copper powder, it is less than satisfactory as conductive filler owing to the migration problem. Although use of a titanate coupling agent as in JPA. No.Sho.61-67702 may suppress silver-induced migration, conductivity is decreased in proportion to the amount of titanate coupling agent present on the particle surfaces. This method also increases cost owing to the need for an additional production step and chemical. Production of a silver-containing copper powder by atomization in the manner of JPB.No.Hei.6-72242 not only requires equipment operable at a high temperature exceeding the melting point but also experiences difficulty in controlling particle diameter.

An object of the present invention is therefore to overcome the foregoing drawbacks of the prior art by providing a silver-containing copper powder that enjoys the conductivity and oxidation resistance improving effect of including silver in copper particles and is also resistant to migration.

### SUMMARY OF THE INVENTION

The present invention achieves this object by providing a process for producing silver-dispersed copper powder comprising a step of subjecting a silver-adhered copper powder composed of copper particles having silver adhered to the surfaces thereof to heat treatment in a non-oxidizing atmosphere at a temperature of 150-600° C. The silver-adhered copper powder subjected to the heat treatment can comprise copper particles whose surfaces have discrete spot-like or island-like metallic silver adhering thereto. Such silver-adhered copper powder can be produced by reacting metallic copper powder and silver nitrate in an aqueous solution containing dissolved reducing agent. Otherwise the silver-adhered copper powder subjected to the heat treatment can comprise copper particles whose surfaces are uniformly adhered with a film of metallic silver. Such silver-adhered copper powder can be produced by causing silver ions to act on copper powder in an aqueous solution of a complex salt. When any of these silver-adhered copper powders are subjected to the heat treatment, the metallic silver present on the copper particle surfaces disperses into the particles to no longer remain as discrete matter on the particle surfaces. This suppresses migration attributable to silver.

By this process, this invention can provide silver-dispersed copper powder comprising 0.5-10 wt % of Ag and the balance of Cu and unavoidable impurities whose particles have substantially no discrete metallic silver on their surfaces and are of an average diameter of not greater than 10 μm. This invention also provides conductive paste using as conductive filler silver-dispersed copper powder comprising 0.5-10 wt % of Ag and the balance of Cu and unavoidable impurities whose particles have substantially no discrete metallic silver on their surfaces and are of an average diameter of not greater than 10 μm.

### BRIEF EXPLANATION OF THE DRAWINGS

FIG. 1 is a scanning electron microscope (SEM) image showing an example of silver-adhered copper powder before heat treatment.

FIG. 2 is an SEM image showing an example of silver-dispersed copper powder obtained by heat-treating the silver-adhered copper powder of FIG. 1.

FIG. 3 is an SEM image showing another example of silver-adhered copper powder before heat treatment.

FIG. 4 is an SEM image showing an example of silver-dispersed copper powder obtained by heat-treating the silver-adhered copper powder of FIG. 3.

FIG. 5 is an equilibrium diagram of copper and silver.

### DESCRIPTION OF THE PREFERRED EMBODIMENT

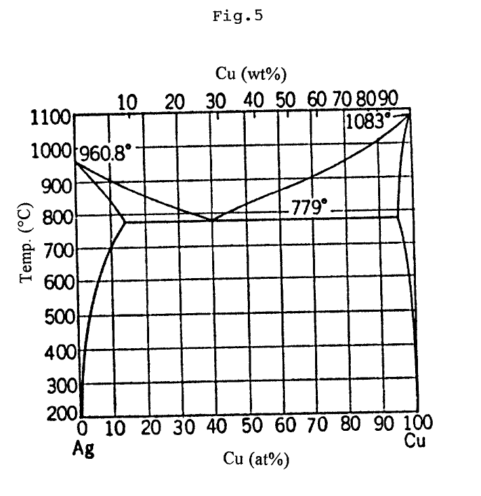

As can be seen from FIG. 5, copper and silver do not enter each other in solid solution to any appreciable extent at a room temperature as viewed in their equilibrium diagram. Maximum Ag dissolution in Cu at the eutectic point of 779° C. amounts to only about 5 at. %. The solution limit falls with decreasing temperature to the point where almost no Ag dissolves in Cu at normal room temperature. Thus, from the viewpoint of the equilibrium theory, almost no solid solution of Ag in Cu would be expected. However, it was discovered that when small-diameter copper particles having discrete metallic silver adhered to their surfaces are heat treated in a non-oxidizing atmosphere, preferably in a weak reducing atmosphere, at an appropriate temperature of 150-600° C., the metallic silver adhering to the surfaces diffuses into the copper particles. In other words, a phenomenon occurs that is indistinguishable from the metallic silver discretely present on the particle surfaces being dissolved into the copper of the particles. After the heat treatment, silver is no long observed on the particle surfaces with a scanning electron microscope (SEM). This phenomenon is herein called the “silver dispersion phenomenon” and the powder having silver dispersed into its particles by this phenomenon “silver-dispersed copper powder.” The silver dispersion phenomenon may be attributable to the fact that the copper base metal is in the form of fine particles so that surface energy comes into play owing to the fine particulate form. The powder composed of copper particles having discrete metallic silver adhering to their surfaces is herein called “silver-adhered copper powder.”

The temperature of the heat treatment is appropriately determined in light of the diameter of the copper particles, the rate of silver adherence to the copper particles, and the state of silver adherence (spot-like, island-like, film-like, etc.) but must be selected in the range of 150-600° C. because the silver does not disperse sufficiently at below 150° C. and sintering among the particles is apt to occur at higher than 600° C. The heat treatment temperature is preferably 200-550° C., more preferably 250-500° C. The holding time at the selected temperature, which also must be selected in light of the particle morphology, is ordinarily in the range of 5-200 min, preferably 100-150 min. The atmosphere in which the heat treatment is conducted is required to be a non-oxidizing atmosphere. An inert gas atmosphere (e.g., a nitrogen gas atmosphere) or, more preferably, a weak reducing atmosphere (e.g., nitrogen gas+not more than 20 vol % of hydrogen gas) is suitable.

The particle diameter of a metallic powder suitable for use as conductive filler is generally around 0.1-10 μm. By carrying out the heat treatment of this invention on a silver-adhered copper powder composed of particles of a diameter in this range, there can be obtained a silver-dispersed copper powder composed of substantially like sized particles of silver-dispersed copper. The silver-dispersed copper powder according to the present invention is composed of 0.5-10 wt % of Ag, preferably 1.0-5.0 wt % of Ag, and the balance of Cu and unavoidable impurities. When Ag content is below 0.5 wt %, the addition of the silver to the copper produces no improvement in oxidation resistance. When it is above 10 wt %, the effect of improving oxidation resistance saturates and further addition should be avoided to prevent cost increase.

When conductive paste is made using a filler of silver-adhered copper powder whose copper particles bear discrete metallic silver, the conductive paste tends to experience migration. In contrast, conductive paste made using a filler of “silver-dispersed copper powder” produced according to the present invention does not readily give rise to migration. The former experiences silver-induced migration but the latter suppresses migration, apparently because the surface property of the powder is dominated by copper rather than silver.

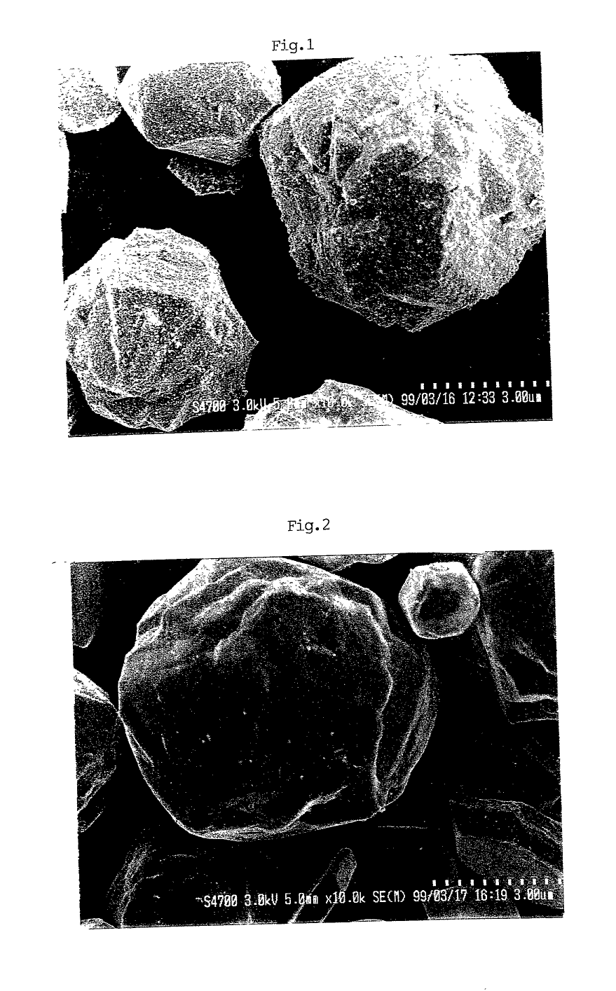

The silver-dispersed copper powder of the invention can be obtained by heat-treating silver-adhered copper powder produced by the wet method. The wet method enables easy control of particle diameter, particle diameter distribution, shape (plate, spherical etc.), state of silver adherence and the like, and can be implemented with relatively simple equipment. The present inventors earlier developed a process for producing silver-adhered copper powder that enables easy control of particle diameter, particle diameter distribution, shape, state of silver adherence and the like, specifically a process for producing silver-adhered copper powder comprising a step of precipitating copper hydroxide by reacting an aqueous solution of a copper salt and an alkali to obtain a suspension containing copper hydroxide, an intermediate reduction step effected by adding a reducing agent to the suspension to reduce the copper hydroxide to cuprous oxide, a final reduction step, conducted after blowing an oxygen-containing gas into the suspension containing cuprous oxide to effect oxidizing treatment, of reducing the cuprous oxide to metallic copper by addition of hydrazine hydrate or an organic reducing agent to the suspension, and a step of adding silver nitrate to the obtained suspension containing the reducing agent and metallic copper powder. This process was applied for patent application under Japanese Patent Application No. 11-054981 (1999) (hereinafter '981) which was published on Sep. 12, 2000 as JPA.No.P2000-248303A. When carried out under appropriate conditions, this process is useful to produce silver-adhered copper powder composed of generally spherical particles of copper whose surfaces have discrete spot-like or island-like metallic silver adhering thereto (as shown in FIG. 1). Silver-dispersed copper powder composed of spherical particles (FIG. 2 discussed later) can be obtained by heat-treating this silver-adhered copper powder.

Distinctive features of the process of producing silver-adhered copper powder described in '981 include that metallic copper powder and silver nitrate are reacted in an aqueous solution containing dissolved reducing agent (reduction potential is lower than −200 mV), that the addition of silver nitrate to the suspension at the final step of the wet method of producing copper powder affords the reaction in an aqueous solution containing dissolved reducing agent together with the metallic copper powder, and that an oxidization step is interposed between the step of primary reduction to cuprous oxide and the step of final reduction to metallic copper in the wet method for producing copper powder. The point of these features set out in '981 is that they enable manipulation of particle diameter, particle size distribution, shape, state of silver adherence, amount of adhered silver and the like with good controllability to provide a silver-adhered copper powder suitable for use in conductive paste. The silver-adhered copper powder subjected to heat treatment to obtain the silver-dispersed copper powder of the present invention is therefore preferably obtained by the process of '981.

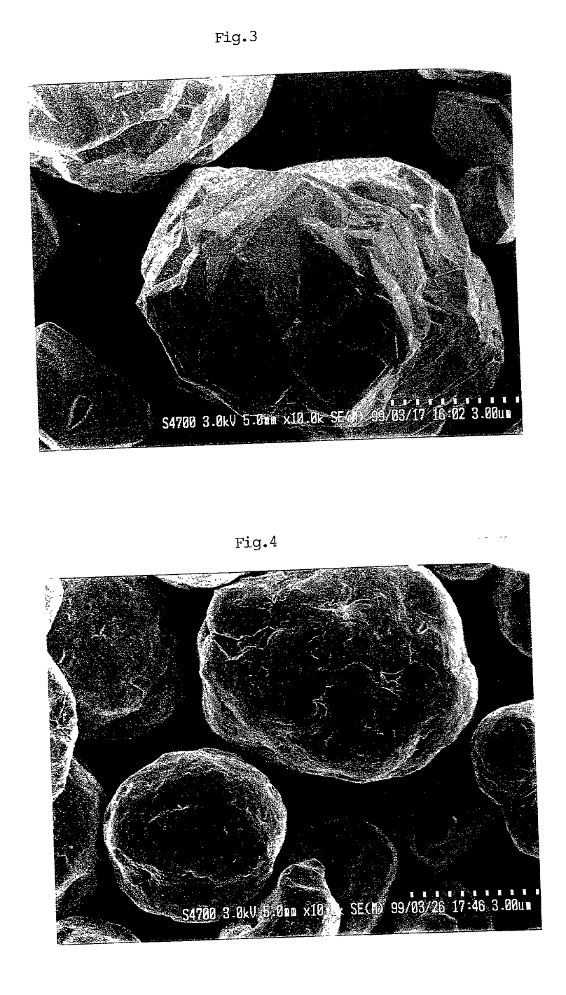

Still, the present invention can also utilize a silver-adhered copper powder produced by any of various conventional methods. Specifically, for example, the invention can be applied to produce silver-dispersed copper powder (like that shown in FIG. 4 discussed later) by heat treating a silver-adhered copper powder produced by causing silver ions to act on copper powder in an aqueous solution of a complex salt or a silver-adhered copper powder obtained by reduction-depositing silver on the surfaces of copper powder particles by the EDTA method to coat the particles with a uniform thin silver film (see FIG. 3 discussed later).

At any rate, a silver-dispersed copper powder endowed with the advantageous properties of both silver and copper can be obtained by producing copper powder by the wet reduction method, adhering silver to the copper powder by the wet method to produce silver-adhered copper powder, and subjecting the silver-adhered copper powder to the heat treatment according to the present invention. The silver-dispersed copper powder can be produced to have a particle diameter of 0.1-10 μm, which is suitable for conductive filler, and to be composed of smooth-surfaced spherical particles. Moreover, as demonstrated in the working examples that follow, it is a characteristic of the silver-dispersed copper powder according to the invention is that, despite its silver content, conductive paste made using the powder does not readily give rise to migration. As a result, conductive paste containing the silver-dispersed copper powder can be used to form high-quality conductors for printed electronic circuits.

### WORKING EXAMPLES

### Example 1

A 27° C. aqueous alkali solution was prepared by adding 4,158 g of pure water to 539 g of an aqueous solution of NaOH of 48% concentration, a 29° C. aqueous solution of copper sulfate was prepared by dissolving 662.5 g of copper sulfate (CuSO₄.5H₂O) in 2,200 g of pure water, the solutions were mixed (pH: 13.7; NaOH present at a chemical equivalent ratio of 1.25 relative to copper contained in the solution), and the mixture was stirred to obtain a suspension of precipitated copper hydroxide. The total amount of a glucose solution prepared by dissolving 993.5 g of glucose in 4,140 g of pure water was added to the total amount of the suspension. The solution rose to a temperature of 70° C. over a 30-min period following the addition and was maintained at this temperature for 15 min thereafter. The processing operations up to this point were conducted throughout under a nitrogen atmosphere. Air was then bubbled into the suspension at a flow rate of 62 ml/min over a period of 200 min. By this, the pH became 6.2.

After the suspension had been allowed to stand for 2 days under a nitrogen atmosphere, the supernatant (pH 7.01) was removed to harvest substantially the total amount of the precipitate. 700 g of pure water was added to the precipitate. To the total amount of the resulting suspension was added 65 g of hydrazine hydrate. The temperature of the suspension was increased 50° C. to a final temperature of 80° C. by heat generated up to completion of the reaction. The suspension after completion of the reaction consisted of metallic copper powder contained in an aqueous solution including dissolved hydrazine hydrate.

The liquid component of the so-obtained suspension consisting of metallic copper powder contained in an aqueous solution including dissolved hydrazine hydrate had a reduction potential of −400 mV and the metallic copper powder therein was about 260 g, which corresponded to substantially equivalent mole of the initial copper sulfate. In order to obtain an amount of silver equivalent to about 3 wt % of this amount of copper, 12.7 of silver nitrate was dissolved in 75 g of pure water and, using a tube pump, the total amount of the aqueous solution of silver nitrate was added under stirring to the suspension of metallic copper powder held at 50° C., continuously in small quantities over a period of 60 min. After completion of the reaction, the suspension was filtered and the filter cake was washed with water and dried to afford silver-adhered copper powder.

FIG. 1 is a scanning electron microscope (SEM) image of the obtained silver-adhered copper powder. As can be seen in FIG. 1, discrete silver was present on surfaces of the individual copper particles (the numerous shiny white specks on the particle surfaces), i.e., discrete metallic silver grains were adhered to the copper surfaces. The diameter of the largest particle seen at the upper right of FIG. 1 was about 5 μm, while the average particle diameter of the powder as a whole 4 μm.

100 g of the so-obtained silver-adhered copper powder was loaded into a stationary heat treatment furnace controlled to an atmosphere of a nitrogen-hydrogen mixed gas stream (nitrogen: 90 l/min, hydrogen: 10 l/min) and subjected to heat treatment at 500° C. for 120 min. An SEM image of the treated product is shown in FIG. 2. As can be seen in FIG. 2, the white specks (discrete metallic silver) visible on the particle surfaces in FIG. 1 had disappeared and the particle exhibited surfaces that were smooth and free of sharp corners throughout. In other words, the heat treatment dispersed the metallic silver scattered over the particle surfaces into the copper of the particles to provide a silver-dispersed copper powder composed of particles having substantially no discrete metallic silver on their outermost surfaces.

The silver-adhered copper powder of FIG. 1 and the silver-dispersed copper powder of FIG. 2 were subjected to the electrical resistance test and migration tests set out below. The results of the tests are shown in Table 1. As controls, copper powder and silver powder of approximately the same average particle diameter as the powders of FIGS. 1 and 2 were also subjected to the migration test. The results for the controls are also shown in Table 1.

Electrical Resistance Test

A paste was prepared by kneading together 30 g of the sample powder and 7.5 g of phenolic resin. A 30 μm-thick coat of the blended material was applied to a glass plate and dried. The volume resistivity of the coat was measured (Ω·cm).

Migration Test

A paste was prepared by kneading together the sample powder phenol resin:BCA at a ratio of 8.4:1.6:0.4 (BCA representing butyl carbitol acetate). Two co-linear 1 mm wide line patterns of the paste formed on a glass plate with a 0.3 mm gap between their line patterns were dried at 150° C. for 15 min in a circulating air drier. A drop of pure water was dripped onto the gap, a voltage (7.5 V) was applied between the two patterns separated by the gap, and the time until the gap became conductive (insulation time) was clocked. The conductive state was discriminated using a voltmeter connected into the power supply circuit.

TABLE 1

| | | | | Migration insulation |
|---|---|---|---|---|
| | | | Electrical resistance | time |
| Sample powder | | Photo | (Ω · cm) | (sec) |
| Silver-adhered cop- | | | 3.86 × 10⁻³ | 50.2 |
| per powder before | | | | |
| heat treatment | | | | |
| Silver-dispersed | | | 3.82 × 10⁻³ | 86.3 |
| copper powder after | | | | |
| heat treatment | | | | |
| Controls | Copper | | 2.90 × 10⁻² | 100.9 |
| | powder | | | |
| | Silver | | — | 4.9 |
| | powder | | | |

It can be seen from the results shown in Table 1 that the migration insulation time of the silver-dispersed copper powder after heat treatment was 36 sec longer that of the silver-adhered copper powder before heat treatment, meaning that migration was suppressed almost to the level of copper powder. The conductivities of the two powders were not substantially different.

### Example 2

An EDTA-Ag solution was prepared by adding a silver nitrate solution obtained by dissolving 12.7 g of silver nitrate in 75 g of pure water to a solution obtained by dissolving 24.4 g of EDTA (ethylenediamine-tetraacetic acid) and 12.0 g of ammonium carbonate in 288.6 g of pure water. Copper powder pulp was prepared by dispersing 260 g of copper powder (average diameter: 5 μm) in a solution prepared by dissolving 41.2 g of EDTA and 41.29 g of ammonium carbonate in 1,438 g of pure water. The copper powder pulp was mixed into the EDTA-Ag and stirred for 30 min. The result was filtered, washed and dried to obtain a silver-adhered copper powder composed of 3 wt % silver and the balance of copper. An SEM image of the obtained silver-adhered copper powder is shown in FIG. 3. As can be seen in FIG. 3, the surfaces of the powder particles were smooth and, unlike the particles shown in FIG. 1, were not dotted with silver specks. Thus the silver-adhered copper powder of FIG. 3 obtained in this Example was composed of copper particles having thin, film-like metallic silver adhered to their surfaces. The diameter of the particle at the center of FIG. 3 was about 6 μm.

The silver-adhered copper powder was heat-treated under the same conditions as in the case of Example 1. An SEM image of the heat-treated product (silver-dispersed copper powder) is shown in FIG. 4. The particles in FIG. 4, like those in FIG. 2, had undergone dispersion of the surface silver into their interiors and exhibited surfaces that were smooth and free of sharp corners throughout. In other words, the heat treatment dispersed the film of metallic silver on the surfaces of the copper particles into the copper of the particles to provide a silver-dispersed copper powder composed of particles having substantially no discrete metallic silver on their outermost surfaces.

This silver-dispersed copper powder was subjected to the electrical resistance test and migration test as described earlier regarding Example 1. The results are shown in Table 2. As controls, copper powder and silver powder of approximately the same average particle diameter were also subjected to the migration test. The results are also shown in Table 2.

TABLE 2

| | | | | Migration insulation |
|---|---|---|---|---|
| | | | Electrical resistance | time |
| Sample powder | | Photo | (Ω · cm) | sec |
| Silver-adhered cop- | | | 2.03 × 10⁻⁴ | 45.1 |
| per powder before | | | | |
| heat treatment | | | | |
| Silver-dispersed | | | 1.97 × 10⁻⁴ | 76.4 |
| copper powder after | | | | |
| heat treatment | | | | |
| Controls | Copper | | 2.90 × 10⁻² | 100.9 |
| | powder | | | |
| | Silver | | — | 4.9 |
| | powder | | | |

It can be seen from the results shown in Table 2 that the migration insulation time of the silver-dispersed copper powder after heat treatment obtained in Example 2 was 30 sec longer that of the silver-adhered copper powder before heat treatment, meaning that migration was suppressed. The conductivity of the silver-adhered copper powder having the adhered film-like metallic silver was somewhat better than that of the heat-treated silver-dispersed copper powder.

As explained in the foregoing, copper powders improved in oxidation resistance and conductivity by incorporation of silver have been found to have the drawback of readily giving rise to migration when used in conductive paste. The present invention overcomes this problem by achieving such improvements by a simple technique that prevents the improved copper powder from readily giving rise to migration. The present invention is therefore capable of providing a silver-containing copper powder that is highly suitable for use as filler for conductive paste.

What is claimed is:

1. A process for producing silver-dispersed copper powder comprising a step of subjecting a silver-adhered copper powder composed of copper particles having silver adhered to the surfaces thereof to heat treatment in a non-oxidizing atmosphere at a temperature of 150-600° C.

2. A process according to claim 1, wherein the silver-adhered copper powder includes copper particles whose surfaces have discrete spot-like or island-like metallic silver adhering thereto and the silver-dispersed copper powder is composed of particles having substantially all of the discrete metallic silver dispersed into the copper of the particles.

3. A process according to claim 1, wherein the silver-adhered copper powder includes copper particles whose surfaces are uniformly adhered with a film of metallic silver and the silver-dispersed copper powder is composed of particles having substantially all of the film of metallic silver dispersed into the copper of the particles.

4. A process according to claim 2, wherein the silver-adhered copper powder is one obtained by reacting metallic copper powder and silver nitrate in an aqueous solution containing dissolved reducing agent.

5. A process according to any of claims 3, wherein the silver-adhered copper powder is one obtained by causing silver ions to act on copper powder in an aqueous solution of a complex salt.

6. A process for producing silver-dispersed copper powder comprising;
a step of precipitating copper hydroxide by reacting an aqueous solution of a copper salt and an alkali to obtain a suspension containing copper hydroxide,
an intermediate reduction step effected by adding a reducing agent to the suspension to reduce the copper hydroxide to cuprous oxide,
a final reduction step, conducted after blowing an oxygen-containing gas into the suspension containing cuprous oxide to effect oxidizing treatment, of reducing the cuprous oxide to metallic copper by addition of hydrazine hydrate or an organic reducing agent to the suspension,
a step of adding silver nitrate to the obtained suspension containing the reducing agent and metallic copper powder to obtain silver-adhered copper powder, and
a step of subjecting the silver-adhered copper powder to heat treatment in a non-oxidizing atmosphere at a temperature of 150-600° C.

7. Silver-dispersed copper powder comprising 0.5-10 wt % of Ag and the balance of Cu and unavoidable impurities whose particles have substantially no discrete metallic silver on their surfaces and are of an average diameter of not greater than 10 μm.

8. Conductive paste using as conductive filler silver-dispersed copper powder comprising 0.5-10 wt % of Ag and the balance of Cu and unavoidable impurities whose particles have substantially no discrete metallic silver on their surfaces and are of an average diameter of not greater than 10 μm.

9. A conductor for a printed electronic circuit using conductive paste containing silver-dispersed copper powder comprising 0.5-10 wt % of Ag and the balance of Cu and unavoidable impurities whose particles have substantially no discrete metallic silver on their surfaces and are of an average diameter of not greater than 10 μm.
